(19) United States
(12) Patent Application Publication
(10) Pub. No.: US 2005/0232638 A1
(43) Pub. Date: Oct. 20, 2005

(54) Methods and apparatus for underwater wireless optical communication

(75) Inventors: Paul Fucile, Waquoit, MA (US); Maurice Tivey, N. Falmouth, MA (US); Enid Sichel, Woods Hole, MA (US); Jack Zhang, Woods Hole, MA (US)

Correspondence Address: FISH & NEAVE IP GROUP;ROPES & GRAY LLP, ONE INTERNATIONAL PLACE, BOSTON, MA, 02110-2624, US

(73) Assignee: WOODS HOLE OCEANOGRAPHIC INSTITUTION, Woods Hole, MA (US)

(21) Appl. No.: 11/099,013

(22) Filed: Apr. 4, 2005

Related U.S. Application Data
(60) Provisional application No. 60/559,330, filed on Apr. 2, 2004.

(51) Int. Cl. H04B 10/00

(52) U.S. Cl. 398/140

(57) ABSTRACT

Low-power, wireless, underwater communication devices with communication capabilities without requiring precision underwater navigation. In one aspect, the systems and methods described herein relate to a transmitter which wirelessly transmits data underwater using light-emitting diodes and a receiver which wirelessly receives data emitted from light-emitting diodes using a photodiode. In one embodiment the light-emitting diodes are blue and in another embodiment the light-emitting diodes are red. The receiving photodiode can, for example, be a silicon photodiode. In yet other embodiments the transmitter transmits data to the receiver according to a standard protocol, for example, the IRDA protocol. In one embodiment the transmitter can communicate with receivers as far as 5 to 10 meters away from the transmitter.

### REFERENCE TO RELATED APPLICATIONS

This application claims priority to U.S. Ser. No. 60/559,330 filed Apr. 2, 2004, entitled Methods and Apparatus for Underwater Wireless Optical Communication, and naming Paul Fucile, Maurice Tivey, Enid Sichel, Jack Zhang as inventors, the contents of which are hereby incorporated by reference.

### BACKGROUND

Manned and unmanned underwater vehicles, as well as stationary underwater sensors and probes have traditionally been limited in their communications capabilities. Such communications typically required wired communications to above-water transmitters or ground stations or sonic modems that need significant power supplies for operation. Undersea research sensors and probes, in particular, suffer from limited power sources and physical inaccessibility. Such devices commonly forgo communication of data in favor of storing data for subsequent physical retrieval. Smaller submersible vehicles, either manned or unmanned, also frequently lack the power supplies necessary to communicate wirelessly.

More recently a method of communicating wirelessly underwater has been developed using inductive or magnetic signaling. However, the inductive communication method requires that a transmitter and receiver nearly touch one another for successful communication to occur (i.e., within approximately 2 cm). The navigational requirements needed to bring a transmitter and receiver that close together, in many cases limits the utility of these devices.

### SUMMARY

The methods and apparatus described herein provide low-power, wireless, underwater communication capabilities without requiring precision underwater navigation. In one aspect, the methods and apparatus described relate to a transmitter which wirelessly transmits data underwater using light-emitting diodes and a receiver which wirelessly receives data emitted from light-emitting diodes using a photodiode. In one embodiment the light-emitting diodes are blue and in another embodiment the light-emitting diodes are red. The receiving photodiode can, for example, be a silicon photodiode. In yet other embodiments the transmitter transmits data to the receiver according to a standard protocol, for example, the IRDA protocol. In one embodiment the transmitter can communicate with receivers as far as 5 to 10 meters away from the transmitter.

In another aspect, the invention relates to methods of underwater communication involving the transmission of data using light-emitting diodes and the receiving of data using photodiodes at distances of around 10 meters.

More particularly, the systems and methods described herein include, a communication system, comprising an optical transducer having an optical transmitter with a single or array of light emitting diodes for generating light within a bandwidth of approximately 400-700 nm, an optical receiver with a single or array of photo detector elements of the type capable of detecting light within the communication bandwidth, and a face plate with a lens disposed in front of the array of receiving photo diodes, a watertight housing sealed to the optical transducer and defining an interior chamber, and a circuit in electrical communication with the optical transmitter and the optical receiver and a communication controller for driving the array of light emitting diodes according to the IRDA communication protocol. The device may optionally include a power cell disposed within the watertight housing and electrically coupled to the circuit and to the optical-transducer to provide power. The power cell may be a battery or other stored energy source. The watertight housing may be dimensionally adapted to fit on a manipulator of the type used with an underwater vehicle or in an underwater environment, and have a clamp coupled to the watertight housing for securing the watertight housing to a moveable or stationary member. The device can a circuit with a driver for driving the array of multiple light emitting diodes to transmit data at a rate of between 9600 BAUD (Bits Per Second) to 4 MBAUD.

The communication system can have a lens that comprises a light collecting lens disposed in front of the array of light emitting diodes for collecting light to direct light onto receiving photodiodes. Further there may be a telemetry interface for exchanging data to a location external to the watertight housing, as well as an acoustic sound generator coupled to the photodetector so that a user guiding the light beam between the transmitter and the receiver can receive a feedback message to keep the light beam hitting the receiver and maintain communication. Optionally to save on power, the device may include a low power sleep mode allowing the communication module to turn itself off by timed prearrangement or by lack of incoming signals. Further it may have a wake-up processor for causing the device to enter into an active state in response to being interrogated by a light beam from the transmitter or by incoming signals to the detector or by prearranged timing.

The device can be placed with a sensor, and a plurality of sensing transducers can form a network having multiple distributed sensing transducers with a data communication network interconnected among the plurality of optical communication devices. A data hub may be provided to allow for data communication among the plurality of devices.

### BRIEF DESCRIPTION OF THE DRAWINGS

The foregoing and other objects and advantages of the invention will be appreciated more fully from the following further description thereof, with reference to the accompanying drawings wherein;

FIG. 1 is a diagram of an underwater sensor equipped with a light-emitting diode communication device according to one embodiment of the invention.

FIGS. 2A and 2B is an image of the test bed system used to test a light omitting diode communication device.

FIG. 3 presents a graph indicating transmission distances given certain light densities; and

FIG. 4 is a cartoon representation of communication between an underwater sensor and an unmanned underwater vehicle.

### DETAILED DESCRIPTION

To provide an overall understanding of the invention, certain illustrative embodiments will now be described, including a system that provides for undersea communication by use of optically generated communication signals. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

In general, an underwater communications device according to one aspect of the methods and apparatus described include at least a transmitter and a signal processor or a receiver and a signal processor. For two way communication, the communications device would utilize both a transmitter and a receiver or a combined transceiver.

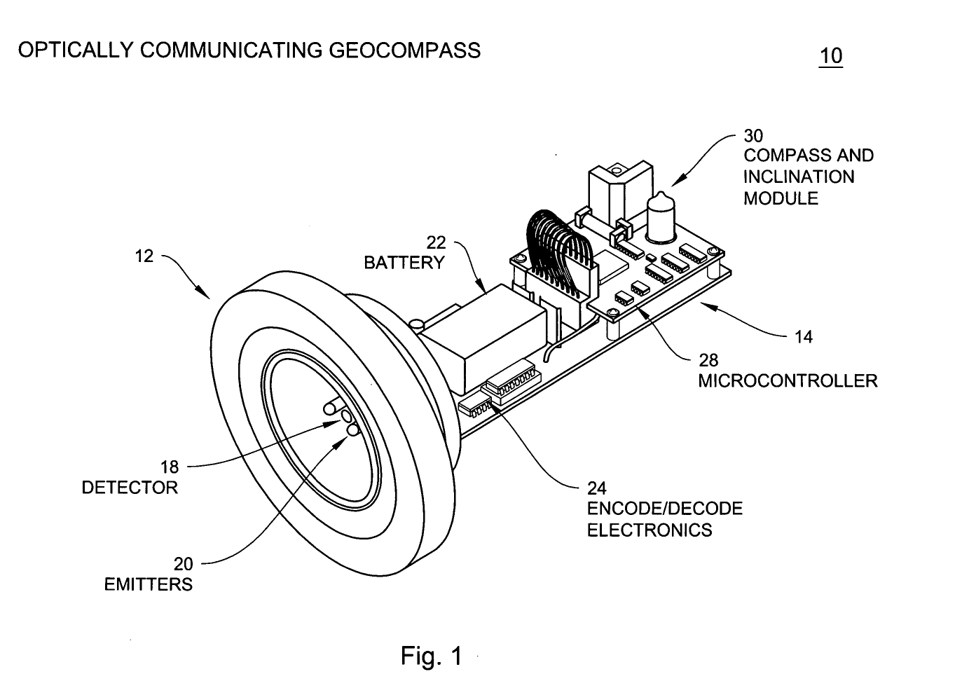

FIG. 1 is a diagram of one illustrative embodiment of the systems described herein that combine a transmitter and a receiver. In the embodiment depicted in FIG. 1, the device 10 is sensor of the type capable of sensing or measuring a physical parameter and generating a signal, typically an electrical signal, that is representative of the measured parameter. In the embodiment depicted in FIG. 1, the depicted sensor 10 is capable of measuring inclination and orientation, and may be used to measure magnetic force at a particular location on the sea floor or at any location.

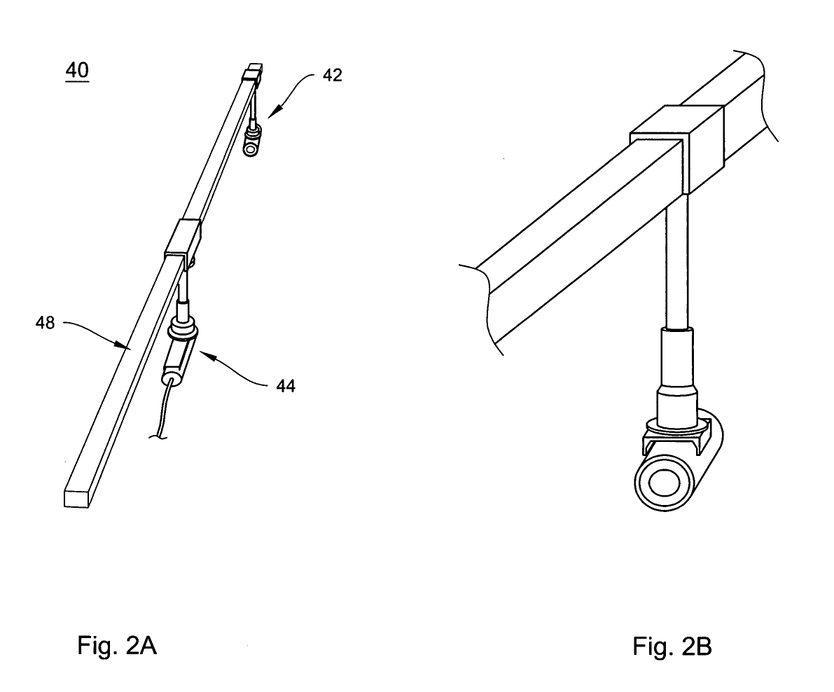

The sensor 10 depicted in FIG. 1 includes an optical transducer 12 located at the distal end of the sensor 10, a circuit 14, a set of detectors 18, a set of emitters 20, a power source 22, a circuit for encoding and decoding communication signals and a data processing device 28, depicted in FIG. 1 as a micro-controller 28. The illustrated optical transducer 12 has the transmitter and receiver combined together onto one surface. In other embodiments, the transmitter and receiver can be physically separated on the communication device/sensor 10. Absent from FIG. 1, but shown in FIG. 2B is a watertight housing sealed to the optical transducer and defining an interior chamber. The circuitry depicted in FIG. 1 can be disposed within the water tight housing.

In one embodiment, the emitters 20 operate in cooperation with the other elements depicted in FIG. 1 as a transmitter, and may include an array of light-emitting diodes arranged in a predetermined pattern, such as a rectangular array, a linear array or any other suitable pattern. Depending on the environment in which the communication by the device 10 will be taking place, either red light-emitting diodes or blue light-emitting diodes are preferable. For example, the emitters 20 may be light emitting diodes operating within a bandwidth of approximately 400-700 nm. Blue light is more conducive to traveling through seawater, but it is more susceptible to scattering in response to particles in the water. Red light is less susceptible to scattering, but does not travel as well through water. In addition, the wavelength of light chosen for transmission may depend on the intended receiver's light detector. For example, silicon photodiodes, as used in some embodiments, are more sensitive to red light than to blue light. Similarly power constraints also apply, as red light-emitting diodes may be more power efficient than blue light-emitting diodes. The actual type of light-emitting diode employed, as well as the number of diodes and the pattern they form within the optical transducer 12 will vary according to the application at hand.

In one embodiment, the emitters may comprise an array of light-emitting diodes 20 and may include between twenty light-emitting diodes up to several hundred light-emitting diodes. In one embodiment, a transducer 12 equipped with 320 red light-emitting diodes successfully communicated data across about five meters of water. A transducer 12 including 300 light-emitting diodes requires on the order of a hundred milliwatts of power for operation. As such, a transducer 12 may be powered for extended periods of time using a standard 9-volt battery as a power source 22, and as depicted in FIG. 1. In additional optional embodiments, the transducer 12 may include a variety of light-emitting diodes for emitters 20 that may be alternatively selected for operation based on the underwater environment and the intended recipient. The light-emitting diodes may operate in concert or they can operate independently to increase bandwidth.

The communication device in sensor 10 may include a receiver according to an illustrative embodiment that includes one or more silicon-photodiodes, though other photodiodes or forms of light detectors can be employed. In the embodiment depicted in FIG. 1, the photodiode provides a detector(s) 18 that may be located in the center of the array of light-emitting diodes. In other embodiments the photodiode may be physically separated from the transmitter array. The receiver 18 typically also includes a lens, such as a Fresnel lens, to focus incoming light from transmitting light-emitting diodes onto the light detector.

The communications device of the sensor 10 may also include a signal processor 24 and a circuit 24 for encoding and decoding communication signals generated and received by the optical transducer 12. To this end, FIG. 1 depicts a encoding/decoding circuit 24 and the microcontroller 28 that may act as a signal processor. These elements may control the optical transducer 12, as well as the emitters 20 and the detectors 18. The signal processor 28 may also encode transmitted data and decode received data.

In one embodiment, the communication device on the sensor 10 transfers data optically according to the infra red data association (IrDA) protocol. IrDA is a standard defined by the IrDA consortium. It specifies a way to wirelessly transfer data via infrared radiation. The IrDA specifications include standards for both the physical devices and the protocols they use to communicate with each other. IrDA devices may communicate using infrared LED's. Wavelengths may be typically around 875 nm +− production tolerance, which is typically around 30 nm. However, the wavelength employed by the systems and methods described herein may vary given that the ambient environment of the devices described herein is typically water, and often seawater. Seawater is a complex mix of materials including organic particulate matter, minerals and biological compounds and beings. To penetrate seawater for any meaningful distance may require wavelengths other than the wavelengths proposed by the IrDA. The systems described herein may use a chip set suitable for driving emitters 20 and detectors 18 according to the IrDA protocol Hewlett Packard manufactures a stand-alone IrDA transmitters, receivers, as well as transceivers. Speeds up to 115 kbps (IrDA 1.0) are available with the HSDL-1000 transceiver. A faster version of the transceiver is the HSDL-1100. It supports FIR speeds (up to 4 Mbit/s). Other IrDA components that may be used by the systems described herein for the encoder/decoder circuit 24 and detectors and or emitters may include the IR LEDs HSDL-4230 and HSDL-4220, standalone PIN receivers as well as IrDA modulation encoder/decoders HSDL-7000. The circuit 24 may include a serial port transmit/receive, an on board clock and optionally a sleep mode. Other manufacturers of IrDA components include Texas Instruments and National Semiconductors.

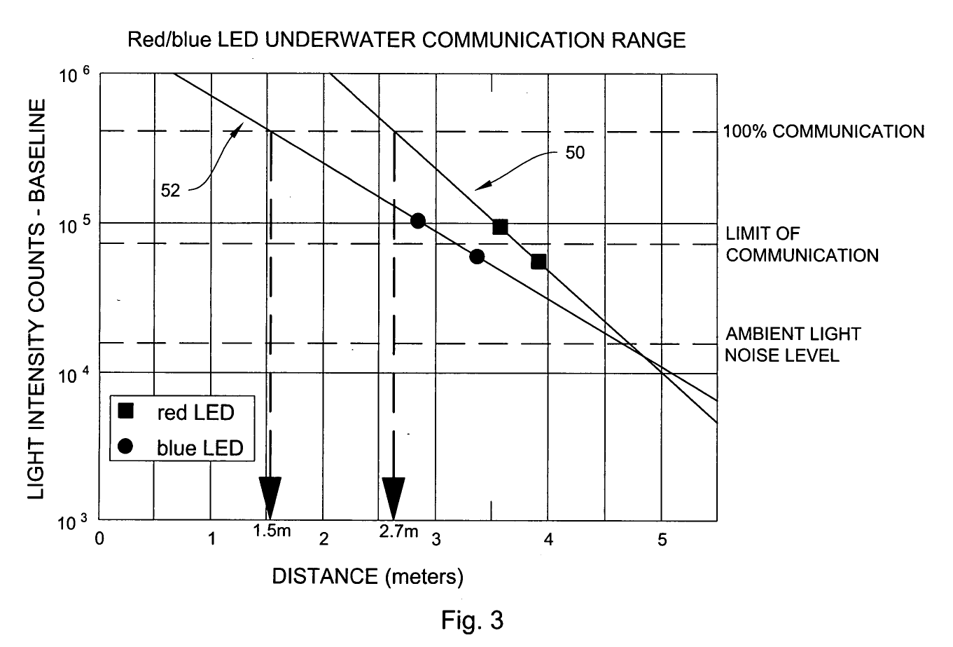

Examples of wavelengths and associated penetration for the purpose of communication are set out in the graph presented in FIG. 3. FIG. 3 depicts the results of experiments conducted using the systems and methods described herein using an assembly similar to the test bed assembly depicted in FIGS. 2A and 2B. In these experiments, the test bed assembly 40 illustrated in FIG. 2A was lowered into seawater off a pier in the North Atlantic. The test bed 40 included two devices 42 and 44 having communication devices similar to the communication devices depicted in FIG. 1. The two devices 42 and 44 are attached to a support bar 48 that can be used to lower the devices 42 and 44 into the water. FIG. 2B illustrates the device 42 in more detail and from a closer perspective. In some embodiments, when in operation, the LEDs glow from the transmitter device, presenting an optically detectable indication that the device is communicating.

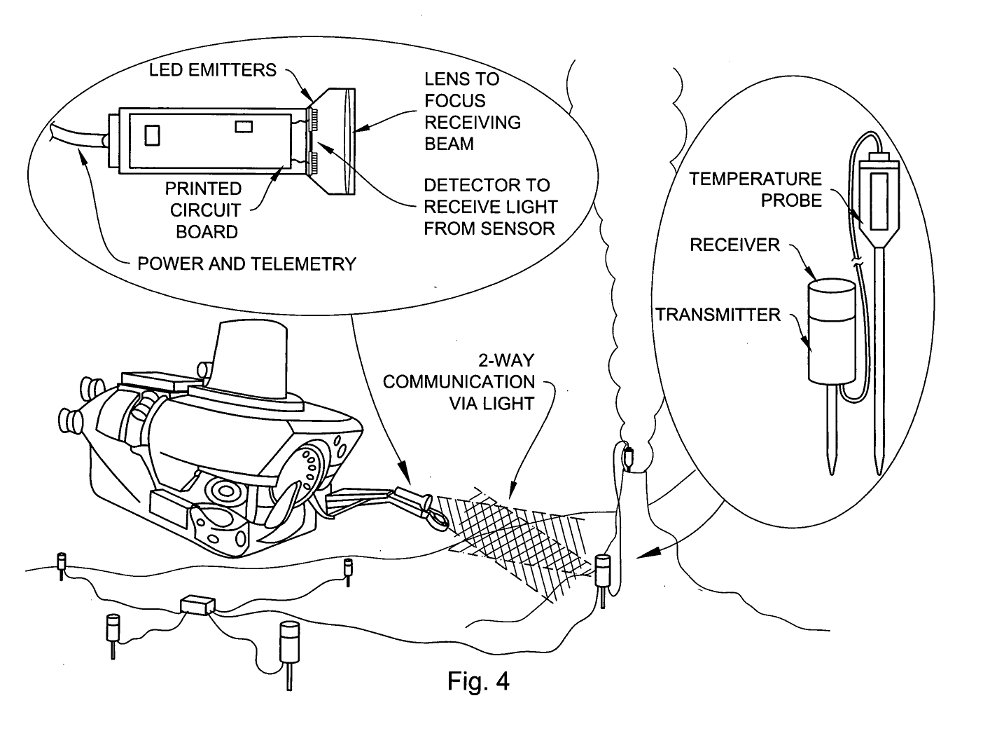

FIG. 3 presents data of the type obtained from experiments that can show the rates of transmission of data over certain distances. More particularly, FIG. 3 depicts a graph that shows on its x-axis the distance between devices, such as devices 42 and 44 shown in FIGS. 2A and 2B. The y-axis presents the light intensity counts. FIG. 4 depicts results from use of the test bed to test both red LEDs and Blue LEDs. The measured intensity of the red LEDs is depicted by line 50 and of the blue LEDs by line 52. During the test, two types of measurements were made; transmitting and receiving a message and counting photons received by the photodiodes. From the dock water clarity was measured and monitored using a C-Star tranmissometer, which gave an average percent of transmission of ˜75%. The results of the tests are depicted by FIG. 3, where for example it is shown that a red LED system having 22 red LEDs formed into a 2-inch diameter array, there was about 100% communication over a range of about 2.7 meters. The maximum range with errors was about 3.7 meters. Given these results, in one embodiment, a system was built with a red LED system having 320 red LEDs formed into a 5-inch diameter array, for which a communicating range of about 5 meters is expected. The power draw for this system is estimated at about 100 milliwatts.

The communications device of FIG. 1 includes additional optional components, including sensor components, for example, a compass and an inclination module. These components can be a substituted for a variety of other components, including temperature sensors, pressure sensors or other forms of sensors, processors, or data storage devices, though no such components are required. The device could merely serve as a data relay or as a beacon. The communication device can also be physically separated from the sensor. For example, the communication device can be hardwired to a nearby sensor.

For operation at increasing depths the entire device can be enclosed within a pressure seal with a optical window allowing for light from the light-emitting diodes to either be transmitted out of the device or to be received at the transmitter.

For communication devices operating according to one embodiment that are located on manned or unmanned vehicles, which are in further communication with human operators, the receiver can also include a squealer device allowing the user to tune the communication between a transmitter and the user's receiver. The squealer may be an acoustic sound generator coupled to the photodetector so that a person in a submarine, such as the one depicted in FIG. 4, guiding the light beam between the transmitter and the receiver can receive a feedback message to keep the light beam hitting the target (the receiver) and not lose the communication link. Additionally, the device may include a “sleep” mode of operation and the “wakeup call” signal. The data gathering module can be designed to turn itself off by timed prearrangement or by lack of incoming signals. It is designed to “wake up” either when interrogated by a light beam from the transmitter or by incoming signals to the detector or by prearranged timing.

FIG. 4 is a cartoon depicting one use of the underwater optical wireless communications device. FIG. 4 depicts an unmanned submersible vehicle, communicating with an underwater probe. The unmanned submersible can be controlled by a surface vessel via tether or other communication link or it can be autonomous. The submersible approaches to within 10 meters of the probe and begins initiating communication with the communications device connected to the probe. Upon the communications device detecting the light emitted by the light-emitting diodes from the submersible, the communications device on the probe can respond by transmitting stored probe data via the probe's transmitter to the receiver located on the submersible. The submersible, for example, could follow a preprogrammed path directing it past several such probes to collect data.

In the embodiment depicted in FIG. 1, the data processing system comprises a micro-controller system that can provide the logic for operating the communication device to communicate data obtained by the sensor component 30. The micro-controller can comprise any of the commercially available micro-controllers including the 8051 and 6811 class controllers. The micro controllers can execute programs for implementing the signal processing functions as well as for controlling the sensor elements. Optionally, the data processing system may be a digital signal processors (DSP) capable of implementing the signal processing functions described herein, such as the DSP based on the TMS320 core including those sold and manufactured by the Texas Instruments Company of Austin, Tex.

The description provided above is intended for illustrative and descriptive purposes and is not intended to limit the scope of the invention to the embodiments described herein. Those skilled in the art will know or be able to ascertain using no more than routine experimentation, many equivalents to the embodiments and practices described herein.

Accordingly, it will be understood that the invention is not to be limited to the embodiments disclosed herein, but is to be understood from the following claims, which are to be interpreted as broadly as allowed under the law. For example, the systems described herein may include a network hub that allows a plurality of devices to be interconnected through a data network. One example of such a system is depicted in FIG. 4, where a plurality of devices are shown as being interconnected to share data. This makes is easier to communicate with an underwater vehicle, that only needs to contact one of the communication devices to receive information gathered by all the devices on the network

1. A communication system, comprising
an optical transducer having an optical transmitter with a single or array of light emitting diodes for generating light within a bandwidth of approximately 400-700 nm,
an optical receiver with a single or array of photo detector elements of the type capable of detecting light within the communication bandwidth, and
a face plate with a lens disposed in front of the array of receiving photo diodes,
a watertight housing sealed to the optical transducer and defining an interior chamber, and
a circuit in electrical communication with the optical transmitter and the optical receiver and a communication controller for driving the array of light emitting diodes according to the IRDA communication protocol.

2. A communication system according to claim 1, further comprising
A power cell disposed within the watertight housing and electrically coupled to the circuit and to the optical-transducer to provide power thereto.

3. A communication system according to claim 2, wherein the power cell is selected from the group consisting of a battery or other stored energy source.

4. A communication system according to claim 1, wherein the watertight housing is dimensionally adapted to fit on a manipulator of the type used with an underwater vehicle or in an underwater environment.

5. A communication system according to claim 1, further comprising
a clamp coupled to the watertight housing for securing the watertight housing to a moveable or stationary member.

6. A communication system according to claim 1, wherein the optical transmitter comprises an array of multiple light emitting diodes.

7. A communication system according to claim 1 wherein
the circuit includes a driver for driving the array of multiple light emitting diodes to transmit data at a rate of between 9600 BAUD (Bits Per Second) to 4 NBAUD.

8. A communication system according to claim 1, wherein light emitting diodes to transmit data at a rate of between 9600 BAUD (Bits Per Second) to 4 MBAUD.

9. A communication system according to claim 1, wherein the lens comprises a light collecting lens disposed in front of the array of light emitting diodes for collecting light to direct light onto receiving photodiode.

10. A communication system according to claim 1, further comprising
A telemetry interface for exchanging data to a location external to the watertight housing.

11. A communications system according to claim 1, further comprising
an acoustic sound generator coupled to the photodetector so that a person in a submarine guiding the light beam between the transmitter and the receiver can receive a feedback message to keep the light beam hitting the receiver and maintain a communication link.

12. A communications system according to claim 1, further comprising
a low power sleep mode allowing the communication module to turn itself off by timed prearrangement or by lack of incoming signals.

13. A communications system according to claim 12, further comprising
a wake-up processor for causing the device to enter into an active state in response to being interrogated by a light beam from the transmitter or by incoming signals to the detector or by prearranged timing.

14. A sensor, comprising
a sensing transducer of the type capable of measuring a physical parameter and generating an information signal representative of that physical parameter, and
an optical communication system having
an optical transducer with a single or array of light emitting diodes for transmitting a communication signal within a wavelength bandwidth of between 400-700 nm, a single or array of photo detectors of the type capable of detecting light within a bandwidth of between 400-700 mm, and a face plate being transmissive to light and having a lens disposed in front of the array of light emitting diodes for collecting light to focus the light onto the photodiode,
a circuit in electrical communication with the optical transducer, the array of light emitting diodes and the array of photodetectors, and
a watertight housing surrounding the optical communication system and the sensing transducer.

15. A sensor according to claim 14, wherein the sensing transducer comprises a plurality of sensing transducers.

16. A sensor according to claim 15, wherein the sensing transducer comprises a network having a plurality of distributed sensing transducers,

17. A communication device, comprising
a plurality of optical communication devices as recited in claim 1,
a data communication network interconnected among the plurality of optical communication devices.

18. A communication device as recited in claim 17, further comprising
a data hub for providing data communication among a plurality of devices.

19. A communication device as recited in claim 17, further comprising
a plurality of sensors coupled in a data communicating relationship with the data communication network.

20. A method for manufacturing a communications device, comprising
forming an optical transmitter from a single or array of light emitting diode(s) capable of generating light within a bandwidth of approximately 400-700 nm,
forming an optical receiver with a single or array of photo detector(s) elements of the type capable of detecting light of a wavelength within the communication bandwidth, and
disposing the optical transmitter and the optical receiver within a watertight housing and placing a face plate with a lens in front of the array of light emitting diode(s) and photodiodes,
providing a watertight housing sealed to the optical transducer and defining an interior chamber, and disposing therein a circuit in electrical communication with the optical transmitter and the optical receiver and a communication controller for driving the LED array according to the IRDA communication protocol.

21. A method according to claim 20, comprising the further step of coupling a sensor to the communication device.

22. A method according to claim 20, comprising the further step of providing a data terminal for communicating data to a source that is external to the watertight housing.

23. A method according to claim 22, comprising the further step of providing a data network capable of communicating data among multiple devices.
